(19) United States
(12) Patent Application Publication
(10) Pub. No.: US 2025/0115270 A1
(43) Pub. Date: Apr. 10, 2025

(54) FUSION OF CLASSICAL COMPUTING, ARTIFICIAL INTELLIGENCE OR QUANTUM COMPUTING FOR VEHICLE OPERATION

(71) Applicant: Volvo Car Corporation, Göteborg (SE)

(72) Inventor: Raik Orbay, Gothenburg (SE)

(21) Appl. No.: 18/482,219

(22) Filed: Oct. 6, 2023

(51) Int. Cl. B60W 60/00; G06N 10/60; G06N 20/00

(52) U.S. Cl. CPC B60W 60/001; G06N 10/60; G06N 20/00; B60W 2556/35

(57) ABSTRACT

Systems/techniques that facilitate fusion of (or multiplexing) classical computing, artificial intelligence, or quantum computing for vehicle operations are provided. In various embodiments, a system can establish computational intensity thresholds for classical computing, artificial intelligence and quantum computing. In various aspects, the system can engage, through fusion of (or multiplexing) classical computing, artificial intelligence, or quantum computing for a vehicle operation based on the vehicle operation's computational intensity. In various instances, the system can engage classical computing, artificial intelligence or quantum computing in parallel or separately for vehicle operation.

### TECHNICAL FIELD

The subject disclosure relates generally to fusion of (or multiplexing) classical computing, artificial intelligence, or quantum computing for vehicle operation.

### BACKGROUND

Artificial intelligence (AI) has made significant strides in vehicle operation, particularly in areas like autonomous driving and driver assistance systems. However, there are several shortcomings and challenges associated with AI in this context. AI has limited common sense and contextual understanding: AI lacks the innate common sense and contextual understanding that humans possess. This can lead to AI misinterpreting situations that are straightforward for humans, which might result in incorrect decisions or actions. AI systems heavily rely on data for learning, and biases present in training data can lead to biased decisions. If training data is not diverse or representative, AI systems might make unfair or unsafe choices. For example, an AI trained on biased data might not recognize pedestrians of certain demographics effectively. AI models often struggle with handling rare or previously unseen scenarios, known as “edge cases.” These situations can challenge the AI's decision-making, as it might not have encountered similar examples during its training. Ensuring safety and reliability of AI-driven vehicles is a major concern. AI systems need to operate correctly under all circumstances, but achieving this is complex due to the unpredictable nature of real-world environments. In semi-autonomous or conditional automation modes, the transition of control between AI and human drivers can be challenging. AI might not accurately assess the human's ability to take over, potentially leading to unsafe handover situations. AI systems might face ethical dilemmas in certain scenarios, such as deciding between saving the occupants of a vehicle or pedestrians in a potential collision. Developing universal ethical guidelines for AI in these situations is difficult. AI often lacks the ability to reason with common sense, making it difficult for the system to handle situations where explicit instructions are missing or incomplete. AI systems, including those used in vehicles, can be vulnerable to adversarial attacks. By manipulating input data in subtle ways, malicious actors can cause AI systems to make incorrect decisions. Collecting and using vast amounts of data for AI in vehicles raises privacy concerns. Balancing the need for data to improve AI performance with protecting user privacy is a complex challenge. While AI can learn from data, it may struggle with continuous learning and adaptation in dynamically changing environments. Ensuring that AI systems can safely and effectively learn from real-world experiences is a challenge. There is a need in the art to mitigate or overcome some of the shortcomings of artificial intelligence in connection with vehicle operation.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate fusion of (or multiplexing) classical computing, artificial intelligence, or quantum computing for vehicle operation.

According to an embodiment, a system, comprises a processor that executes computer-executable components stored in a non-transitory quantum or non-quantum computer-readable memory, the computer-executable components comprising: a classical computing component; an artificial intelligence component; a quantum computing component; and a fusion component that dynamically engages one of more of the classical computing component, the artificial intelligence component or the quantum computing component in connection with operation of a vehicle.

Quantum memory can store and retrieve quantum information, typically encoded in quantum bits or qubits. Unlike classical computer memory, which stores information as bits (e.g., 0s and 1s), quantum memory can store superposition states and entangled states, allowing for versatile and effective storage of quantum.

According to an embodiment, computer-implemented method, comprises: using a fusion component to dynamically engage one of more of a classical computing component, an artificial intelligence component or a quantum computing component in connection with operation of a vehicle.

According to yet another embodiment, a computer program product comprises a non-transitory quantum or non-quantum computer-readable memory having program instructions embodied therewith, the program instructions executable by a processor to cause the processor to: use a fusion component to dynamically engage one of more of a classical computing component, an artificial intelligence component or a quantum computing component or a quantum memory component in connection with operation of a vehicle.

According to one or more embodiments, the above-described systems can be implemented as computer-implemented methods or computer program products.

### DESCRIPTION OF THE DRAWINGS

FIG. 1 illustrates a block diagram of an example, non-limiting system that facilitates fusion of (or multiplexing) classical computing, artificial intelligence, or quantum computing for vehicle operation in accordance with one or more embodiments described herein.

FIG. 2 illustrates a block diagram of an example, non-limiting system including quantum sensors that facilitates fusion of (or multiplexing) classical computing, artificial intelligence, or quantum computing for vehicle operation in accordance with one or more embodiments described herein.

FIG. 3A illustrates a block diagram of an example, non-limiting system including a routing component that facilitates fusion of (or multiplexing) classical computing, artificial intelligence, or quantum computing for vehicle operation in accordance with one or more embodiments described herein.

FIG. 3B illustrates a diagram of an example, non-limiting that facilitates fusion of (or multiplexing) classical computing, artificial intelligence or quantum computing for vehicle operation in accordance with one or more embodiments described herein.

FIG. 4 illustrates a block diagram of an example, non-limiting system including an energy management component and encryption component that facilitates fusion of (or multiplexing) classical computing, artificial intelligence or quantum computing for (embedded) vehicle operation in accordance with one or more embodiments described herein.

FIG. 5 illustrates a block diagram of an example, non-limiting system that facilitates fusion of (or multiplexing) classical computing, artificial intelligence or quantum computing for vehicle operation in accordance with one or more embodiments described herein.

FIG. 6A illustrates a block diagram of an example, non-limiting system including a deep learning neural network that facilitates fusion of (or multiplexing) classical computing, artificial intelligence or quantum computing for vehicle operation in accordance with one or more embodiments described herein.

FIG. 6B illustrates a diagram of an example, non-limiting system that facilitates fusion of (or multiplexing) classical computing, artificial intelligence or quantum computing for vehicle operation in accordance with one or more embodiments described herein.

FIG. 6C illustrates an example, non-limiting system that facilitates fusion of (or multiplexing) classical computing, artificial intelligence or quantum computing for vehicle operation in accordance with one or more embodiments described herein.

FIG. 7 illustrates a flow diagram of an example, non-limiting computer-implemented method that facilitates fusion of (or multiplexing) classical computing, artificial intelligence or quantum computing for vehicle operation in accordance with one or more embodiments described herein.

FIG. 8 illustrates a flow diagram of an example, non-limiting computer-implemented method that facilitates optimizing energy usage for fusion of (or multiplexing) classical computing, artificial intelligence or quantum computing for vehicle operations in accordance with one or more embodiments described herein.

FIG. 9 illustrates a flow diagram of an example, non-limiting computer-implemented method that facilitates fusion of (or multiplexing) classical computing, artificial intelligence and quantum computing for vehicle data encryption in accordance with one or more embodiments described herein.

FIG. 10 illustrates a block diagram of an example, non-limiting operating environment in which one or more embodiments described herein can be facilitated.

FIG. 11 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

AI in vehicle operations involve integrating advanced technologies such as sensors, machine learning, and algorithms to enhance driving and vehicle functionality. Furthermore, AI enables autonomous driving, sensor fusion, intelligent decision-making, and safety features by improving driver assistance, traffic prediction, personalized experiences, and maintenance.

Unfortunately, existing techniques for performing vehicle operations through classical computing and artificial intelligence can be unreliable for various reasons.

First, modern vehicles are equipped with advanced sensors, cameras, and communication technologies that collect and transmit vast amounts of data. Connected cars might contain sensitive personal information about the driver and passengers (e.g., location history, travel patterns, biometric data) that is sent to the vehicle manufacturer's cloud servers for analysis and improvement of vehicle performance and personalized services to drivers. However, such data is susceptible to cyberattacks and unauthorized access, threatening data privacy. Furthermore, data breaches and personal information exposure might lead to exploitation of such data for malicious purposes (e.g., identity theft, stalking).

Second, AI-driven systems must be dependable and capable of making instantaneous decisions in complex, dynamic, and unpredictable situations (e.g., heavy traffic, adverse weather, unexpected obstacles, standing-still vehicles, sensor failures). However, AI-driven systems may struggle to reliably handle such situations (e.g., the AI vehicle system is unable to assess the speed and position of other vehicles, anticipate gaps, and make sufficiently quick decisions in heavy traffic), leading to potential accidents. If an AI algorithm or sensor is not designed to handle adverse weather conditions (e.g., rain, snow, fog, low-light situations, adverse light conditions, whiteouts), the system's reliability might be compromised. That is, reduced visibility and sensor interference due to adverse weather conditions can affect the system's ability to perceive and navigate its environment. For example, in a whiteout (e.g., heavy snowfall or blizzard conditions when visibility is severely reduced due to the blowing and drifting of snow, creating a white, featureless landscape) AI sensors in a vehicle can struggle or even fail due to loss of reference points. AI systems often rely on distinct reference points (e.g., road markings, landmarks) to navigate and localize themselves. Accordingly, a whiteout obscures such reference points, making it difficult for the system to determine the vehicle's position accurately. Furthermore, in whiteout conditions, it can be challenging for AI systems to differentiate between genuine obstacles (e.g., other vehicles, pedestrians) and false positives caused by the snow-covered surroundings. The occurrence of false positive detections, where the system applies the brakes unnecessarily due to a perceived collision risk that doesn't actually exist, can lead to abrupt and unnecessary stops, potentially causing confusion to other drivers or accidents due to sudden deceleration. Conversely, false negatives might occur when the system fails to detect a genuine collision risk, leading to a failure to apply the brakes when necessary. This can result in the occurrence of preventable accidents had the system reacted appropriately.

Third, AI systems often encounter situations that fall outside the scope of their training data, known as edge cases. Handling edge cases requires robust and adaptable AI algorithms. Such situations can otherwise confuse AI algorithms, potentially leading to incorrect decisions. For example, an autonomous vehicle may encounter a pedestrian who is acting unpredictably (e.g., walking in a zigzag pattern, behaving erratically) and inaccurately predict the pedestrian's next move and the safest course of action to avoid a collision. Moreover, an autonomous vehicle might encounter construction zones with temporary road markings, road flooding, unclear signage, and unanticipated obstacles. The AI system might not have encountered such road conditions during its training and thus, might find it challenging to make accurate decisions in this unfamiliar environment. Wildlife encounters (e.g., a deer crossing the road) can also result in the AI system of an autonomous vehicle to incorrectly identify the wildlife due to difficulty distinguishing the animal from other objects, meaning the vehicle may incorrectly determine the appropriate response to avoid collisions without causing danger to surrounding vehicles.

Accordingly, systems or techniques that can address one or more of these technical problems can be desirable.

Various embodiments described herein can address one or more of these technical problems. One or more embodiments described herein can include systems, computer-implemented methods, apparatus, or computer program products that can facilitate fusion of (or multiplexing) classical computing, artificial intelligence, or quantum computing for vehicle operation. That is, the present inventors realized that various disadvantages associated with existing techniques for performing vehicle operations can be ameliorated by fusion of (or multiplexing) classical computing, artificial intelligence or quantum computing for vehicle operation. The subject invention relates to fusion of (or multiplexing) classical computing, artificial intelligence, and quantum computing to optimize various strings of the modalities of vehicle operations.

Quantum computing leverages the principles of quantum mechanics to process information and perform computations in ways that are fundamentally different from classical computing. At the core of quantum computing are quantum bits, or qubits. Unlike classical bits, which can represent either a 0 or a 1, qubits can exist in a superposition of both 0 and 1 states simultaneously. The superposition property allows quantum computers to perform certain types of calculations much faster than classical computers and artificial intelligence by enabling the exploration of multiple possibilities in parallel. Quantum computing also leverages entanglement. Qubits can become entangled, meaning the state of one qubit becomes dependent on the state of another qubit, allowing correlations between qubits that can be exploited for various computational tasks. Furthermore, quantum computations use interference to amplify correct solutions while canceling out incorrect ones. This process increases the likelihood of obtaining the correct answer in the final measurement.

In various instances, entanglement and interference principles can enable enhanced environmental awareness. This can include modelling and performance prediction of autonomous driving operations (e.g., monitoring traffic conditions in real time, assessing essential vehicle components such as the powertrain or battery). Furthermore, quantum entanglement over longer distances could provide a thoroughly secure and fast communication network for vehicles. Cars can communicate with each other, infrastructure, or central control systems over large distances, allowing for efficient traffic management, safety, and real-time updates on road conditions. Moreover, quantum communication's long-distance capabilities through use of entanglement can enable robust communication between self-driving cars and traffic management systems, reducing the risk of accidents and enhancing overall efficiency of autonomous driving networks.

In various embodiments, the fusion component can engage the classical computing component for vehicle operations of computational intensity below a first threshold. The first threshold consists of routine control tasks, basic sensor data processing, and other low complexity tasks (e.g., locking a door, turning switches on and off, changing the radio). In various aspects, the fusion component can engage the artificial intelligence component for vehicle operations of computational intensity below a second threshold and above the first threshold. Vehicle operations of relatively complex computational intensity in managing complex decision-making, object recognition, natural language processing for human-vehicle interaction, and predictive modeling constitute the second threshold (e.g., natural language processing to enable voice recognition, personalizing in-car experience by learning driver preferences, entertainment choices, and navigation habits). In various embodiments, the fusion component can engage the quantum computing component for vehicle operations above the second threshold. More specifically, the quantum computing component is engaged for specific problems where quantum algorithms provide a significant advantage over classical computing and artificial intelligence (e.g., optimize AI models, speed up pattern recognition problems for image recognition, optimize complex vehicle routing). For example, in adverse weather conditions like a whiteout, a quantum system can delineate objects in a snowstorm more accurately than artificial intelligence. Thus, in various instances, the vehicle can predict collisions, possible sliding, or obstacles with higher accuracy. Moreover, vehicle operations of computational intensity above the second threshold can further comprise creation of synthetical data to accurately determine critical data specific for the vehicle used by the driver; (e.g., battery temperature prediction, electric motor soft magnet saturation distribution, unknown unknowns as component failure causality, road condition assessment, traffic sign recognition, prediction of intentions of multiple cooperating or non-cooperating pedestrians or drivers). In various aspects, a vehicle can be outfitted with quantum-enhanced sensors. More specifically, the vehicle can utilize such external sensors to leverage superposition, entanglement, quantum interference, and noise reduction to provide sensitivity and precision in measuring physical quantities. It should be appreciated that the herein figures and description provide non-limiting examples of various embodiments and are not necessarily drawn to scale.

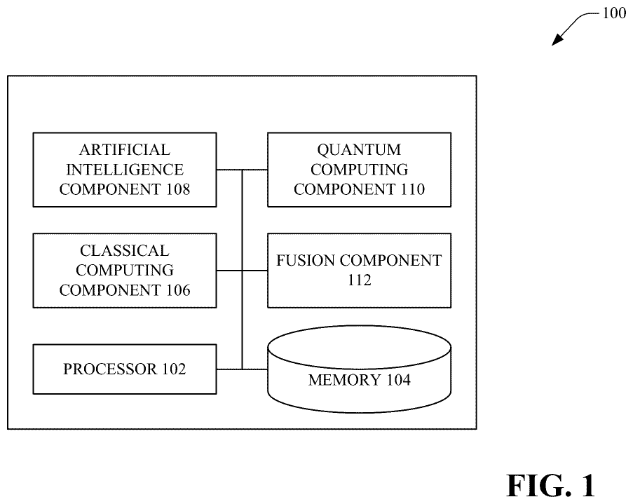

FIG. 1 illustrates an example, non-limiting block diagram 100 showing a vehicle system, where such vehicle can facilitate multiplexing classical computing, artificial intelligence and quantum computing for vehicle operation in accordance with one or more embodiments described herein.

In various aspects, the vehicle can be any suitable vehicle or automobile (e.g., can be a car, a truck, a van, a motorcycle, plane, boat, helicopter). In various instances, the vehicle can have or otherwise exhibit any suitable type of propulsion system (e.g., can be an electric vehicle, can be a gasoline-powered or diesel-powered vehicle, can be a hybrid vehicle). In some cases, the vehicle can be driving on any suitable road, street, lane, or highway at any suitable speed. In other cases, the vehicle can, while driving, be stopped at an intersection, at a traffic light, at a stop sign, at a cross-walk, or at a traffic jam. In yet other cases, the vehicle can be parked rather than driving (e.g., can be parked in a parking lot, by a curb, or in a driveway). In any case, the vehicle can comprise, have, or otherwise be outfitted or equipped with the system 100. In other words, the system 100 can be onboard the vehicle.

In various embodiments, the system 100 can comprise a processor 102 (e.g., computer processing unit, microprocessor) and a non-transitory quantum or non-quantum computer-readable memory 104 that is operably or operatively or communicatively connected or coupled to the processor 102. The non-transitory quantum or non-quantum computer-readable memory 104 can store computer-executable instructions which, upon execution by the processor 102, can cause the processor 102 or other components of the system 100 (e.g., classical computing component 106, artificial intelligence component 108, quantum computing component 110, fusion component 112) to perform one or more acts. In various embodiments, the non-transitory quantum or non-quantum computer-readable memory 104 can store computer-executable components (e.g., classical computing component 106, artificial intelligence component 108, quantum computing component 110, fusion component 112), and the processor 102 can execute the computer-executable components.

In various embodiments, the system 100 can comprise a classical computing component 106. In various aspects, as described herein, the classical computing component 106 can perform basic and routine operations of computational intensity below the first threshold, as specified before. For example, the classical computing component 106 can be engaged to carry out basic control systems (e.g., operating turn signals, controlling multimedia, adjusting side view mirrors).

In various embodiments, the system 100 can comprise an artificial intelligence component 108. In various instances, as described herein, the artificial intelligence component 108 can perform vehicle operations requiring computational intensity above the first threshold and below the second threshold. For relatively complex tasks that require computational intensity incapable for the classical computation component 106 (e.g., navigation, natural language processing enabling voice recognition, monitoring tire pressure), the artificial intelligence component 108 can be engaged.

In various embodiments, the system 100 can comprise a quantum computing component 110. In various cases, as described herein, the quantum computing component 110 can perform vehicle operations requiring computational intensity above the second threshold. For operations requiring complex computational intensity where quantum algorithms provide a significant advantage over artificial intelligence (e.g., optimizing complex routing, obstacle detection in a blizzard, secure data privacy, digital-twin of vehicle components for performance monitoring and prediction), the quantum computing component 110 can be engaged.

In various embodiments, the system 100 can comprise a fusion component 112. In various cases, as described herein, the fusion component 112 can dynamically engage one of more of the classical computing component 106, the artificial intelligence component 108, or the quantum computing component 110 to perform vehicle operation utilizing task allocation based on computational intensity. In various instances, the fusion component 112 can engage one of the classical computing component 106, the artificial intelligence component 108, or the quantum computing component 110 in parallel, in addition to separately.

For example, the classical computing component 106 can be engaged in parallel with the artificial intelligence component 108 to achieve adaptive cruise control. More specifically, classical computing can handle the real-time operations of the vehicle (e.g., reading sensor data, controlling throttle and brakes based on driver inputs). Simultaneously, AI algorithms can learn from driver behavior and real-world data to adjust adaptive cruise control over time. For instance, if a driver frequently intervenes in adaptive cruise control mode, the artificial intelligence component 108 can learn to provide smoother acceleration and braking transitions to match the driver's preferences. As another example, the fusion component 112 can engage the artificial intelligence component 108 in parallel with the quantum computing component 110 to accelerate various vehicle operations. For instance, quantum computing can be engaged to accelerate pattern recognition performed by the artificial intelligence component 108 (e.g., accelerated obstacle detection in roadways). Quantum computing can be applied to data preprocessing tasks (e.g., feature extraction, generate feature maps) while artificial intelligence processes the data to accelerate efficiency and enhance accuracy. Moreover, artificial intelligence techniques can be integrated with quantum-computed distances to further accurately and efficiently identify patterns and objects in visual inputs.

Furthermore, the classical computing component 106 can be engaged in parallel with the artificial intelligence component 108 and the quantum computing component 110 to achieve vehicle performance and autonomous driving. More specifically, quantum computing can handle the real-time operations of a vehicle (e.g., predicting sensor data and environmental situations, predicting the behavior of nearby drivers under the influence) while the artificial intelligence component 108 and classical computing component are engaged for autonomous driving.

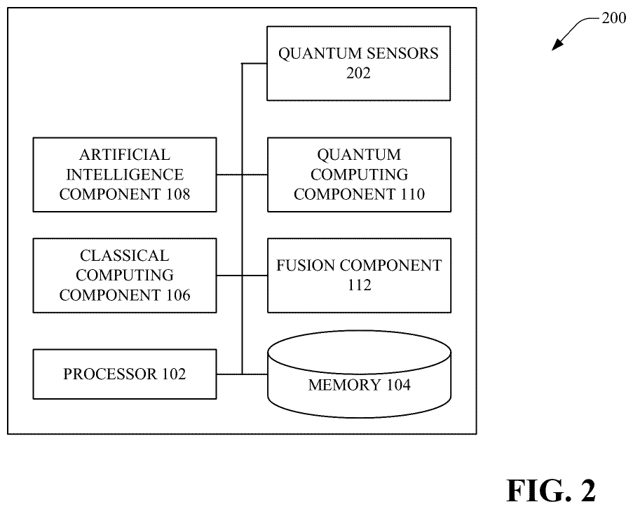

FIG. 2 illustrates a block diagram of an example, non-limiting system 200 that can facilitate fusion of (or multiplexing) classical computing, artificial intelligence, or quantum computing of vehicle operation in accordance with one or more embodiments described herein. As shown, the system 200 can, in some cases, comprise the same components as the system 100, and can further comprise a set of quantum sensors 202.

In various aspects, the quantum sensors 202 can accurately and precisely obtain measurements of physical quantities of the surrounding environment through utilization of various quantum principles (e.g., superposition, entanglement, interference). For example, quantum-enhanced sensors (e.g., quantum radar, LiDAR) utilize quantum properties of light. (e.g., squeezed states) to enhance the detection of objects, providing sensitive and accurate distance measurements. Furthermore, the quantum sensors 202 can monitor additional environment conditions (e.g., pollutant detection, air quality, identify gases in the vicinity) that normal sensors are incapable of measuring and, for instance, enable the artificial intelligence component 108 to use such data to adjust vehicle air filtration or provide real-time environmental data to the driver. In other instances, the quantum computing component 110 can access the environmental data the quantum sensors 202 detect to predict environmental conditions. More specifically, the quantum sensors 202 can measure various environmental conditions (e.g., pressures, temperatures, dew points, wind conditions, humidity) to determine if weather conditions are met to form various hazardous conditions and evoke cautious driving practices or avoidance of dangerous obstacles. For example, the quantum sensors 202 can detect the required weather conditions for black ice formation. If those weather conditions are met (e.g., subfreezing temperatures, the presence of moisture, calm winds, low dew points), the quantum computing component 110 can utilize the collected data to predict the presence of black ice to implement and maintain careful driving (e.g., gentle braking, slower speeds, increased following distances). In various aspects, facial recognition through the quantum sensors 202 can be utilized to provide customizable passenger or driver experiences. For example, when a certain driver is detected, the vehicle can adjust comfortability settings preferred by that driver (e.g., change seat position, mirror adjustments, or radio station based on the driver). The artificial intelligence component 108 can learn patterns of the preferred settings of each driver and adjust the settings accordingly.

In various instances, the quantum sensors 202 can be utilized within the vehicle to monitor driver and passenger behavior to adjust in-cabin comfortability or implement safety measures (e.g., temperature adjustments). For example, the quantum sensors 202 can externally and accurately detect cabin and body temperatures of vehicle passengers. If a passenger is detected to have an unusually high temperature and displaying behavior that shows discomfort, the vehicle can, for instance, adjust cabin temperatures or open and close windows to provide comfortability to the passengers (e.g., opening a rear window for a dog that is overheating in the backseat, raising cabin temperatures for a child that is exhibiting symptoms of being excessively cold). Furthermore, the quantum sensors 202 can utilize quantum mechanics to detect driver facial patterns and behaviors to implement safety measures that prevent collisions and passenger injury. For example, the vehicle can implement safety measures if the quantum sensors detect driver exhaustion (e.g., signal the driver, raise radio volumes, lower cabin temperatures, activate autonomous driving). Moreover, the quantum sensors 202 can measure and monitor other physiological factors (e.g., heart rate, blood pressure, brain activity, breath) of a passenger without contact that conventional sensors are unable to assess. The quantum computing component 110 can assess these factors and determine driving capability of the driver (e.g., monitored vitals show possibility of medical emergency, the quantum sensors 202 detect high blood alcohol concentration from the driver). If, based on the physiological factors measured by the quantum sensors 202, the quantum computing component 110 assesses that the driver is incapable to drive safely, the appropriate safety measures can be executed on the vehicle.

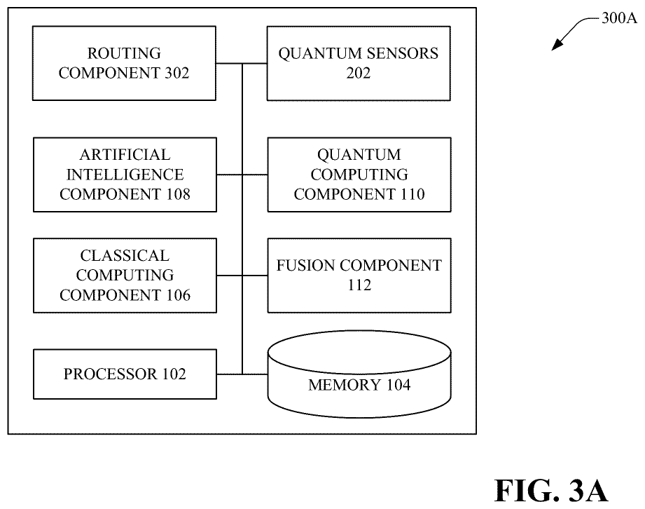

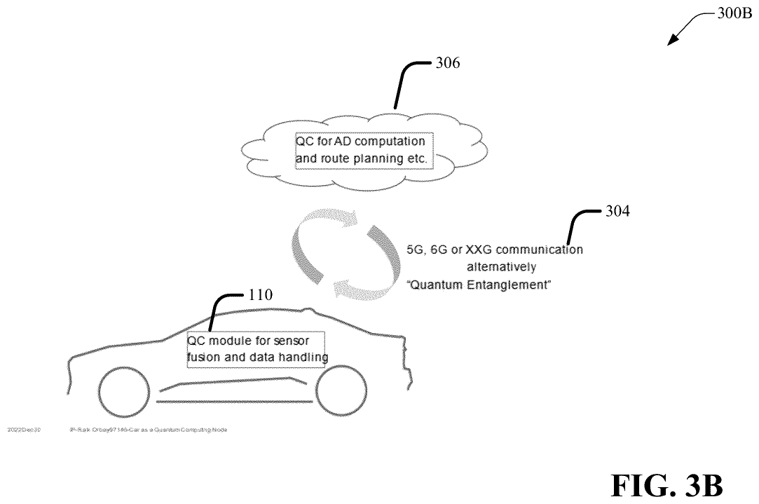

FIG. 3A illustrates a block diagram of an example, non-limiting system 300A, including a routing component, that can facilitate fusion of (or multiplexing) classical computing, artificial intelligence, or quantum computing of vehicle operations in accordance with one or more embodiments described herein. As shown, the system 300A can, in some cases, comprise the same components as the system 200, and can further comprise a routing component 302.

In various instances, the routing component 302 can determine and guide a vehicle's route from a starting point to a destination by use of various sources of real-time traffic data (e.g., GPS data, digital map data, aggregated and anonymized cellular network data, historical traffic data). In various aspects, the fusion component 112 can engage, separately or in parallel, one or more of the classical computing component 106, the artificial intelligence component 108, or the quantum computing component 110 to, using the routing component 302, to optimize vehicle routing based on computational intensity.

For example, if, based on traffic data, the vehicle will encounter a complex traffic situation that extends beyond the second threshold of computational ability for the artificial intelligence component 108, the routing component 302 can engage the quantum computing component 110 to optimize vehicle routing in real time. Quantum algorithms (e.g., Quantum Approximate Optimization Algorithm) can explore different combinations of routes simultaneously, allowing for rapid convergence to optimal solutions. Moreover, by employing the quantum computing component 110, the routing component 302 can implement dynamic route optimization. Quantum computing can process large datasets in parallel and enable real-time dynamic route optimization by adjusting routes as traffic conditions change to ensure optimal delivery times (e.g., an accident occurs on the current route, causing another route to be quicker). Furthermore, multi-objective optimization can be achieved through quantum computation, meaning multiple conflicting objectives can be optimized simultaneously (e.g., minimizing travel distance while maximizing fuel efficiency). Conversely, in standard routing situations, the routing component 302 can engage the artificial intelligence component for vehicle routing. For example, when there is little to no traffic, the routing component 302 can use the artificial intelligence component 108 in place of the quantum computing component 110 to enhance resource management and optimize energy usage.

FIG. 3B illustrates a block diagram of an example, non-limiting networking environment 300B that can facilitate fusion of (or multiplexing) classical computing, artificial intelligence, or quantum computing of vehicle operations in accordance with one or more embodiments described herein.

In various aspects, the quantum computing component 110 can enable data handling and sensor fusion. Sensor fusion allows data from multiple sensors to be combined, integrated, and analyzed to provide a comprehensive and accurate understanding of the surrounding environment and internal vehicle operations. Quantum computing can enhance sensor fusion for data handing of vast amounts of data in real-time for autonomous driving. Furthermore, parallelism can be achieved by utilizing quantum computing for sensor fusion. Due to superposition, multiple calculations can be performed simultaneously.

In various embodiments, there can be a communication link 304 between the quantum computing component 110 and a cloud-based quantum computer 306. The communication link can be fifth generation (5G), sixth generation (6G), or any future generation of wireless communication. Furthermore, quantum entanglement can rather be used to enable distributed parallel data. For example, two or more qubits can be entangled, meaning their quantum states are correlated with each other. When qubits are entangled, the state of one qubit is intrinsically connected to the state of another, regardless of the distance separating them. Each qubit in an entangled pair can exist in a superposition of states, like individual qubits, meaning they can simultaneously represent multiple values or states. Information can be encoded in entangled qubits in such a way that when one qubit is measured, the measurement outcomes of both qubits can effectively be obtained. Thus, entangled qubits can be utilized to distribute parallel data simultaneously. Moreover, parallel data distribution can enable real-time decision making (e.g., collision avoidance, adaptive cruise control, lane-keeping assistance, real-time route optimization). For example, parallel processing can allow the vehicle to process sensor data concurrently and identify potential safety hazards instantaneously (e.g., avoiding a collision from wildlife roadway crossings). Furthermore, a seamless autonomous driving environment can be implemented by utilizing parallel distributed data through quantum entanglement with the cloud-based quantum computer 306.

In various embodiments, quantum computing modules can share information and data through vehicle-to-vehicle (V2V) communication. In various instances, utilizing quantum entanglement to execute V2V communication can enable shared pattern recognition between both vehicles. More specifically, the quantum computing module of one vehicle can delegate pattern recognition tasks (e.g., traffic sign detection) to the quantum computing module on a separate vehicle while still handling other tasks itself. Moreover, the vehicle can also delegate pattern recognition tasks to the cloud-based quantum computer 306.

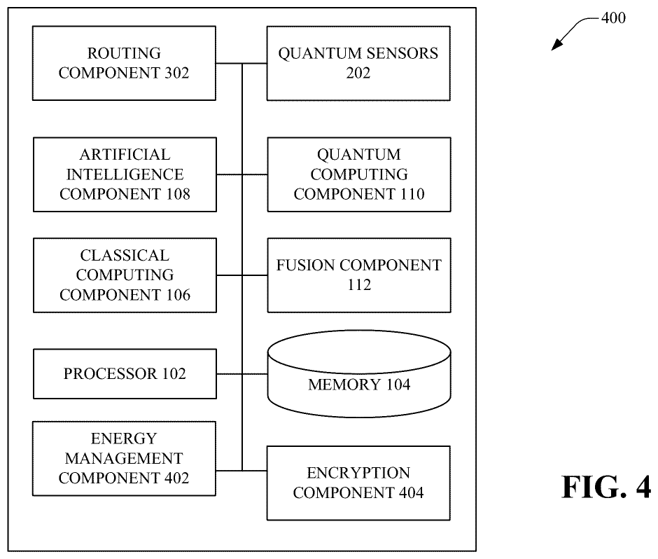

FIG. 4 illustrates a block diagram of an example, non-limiting system 400, including an energy management component and an encryption component, that can facilitate fusion of (or multiplexing) classical computing, artificial intelligence, or quantum computing of vehicle operations in accordance with one or more embodiments described herein. As shown, the system 400 can, in some cases, comprise the same components as the system 300A, and can further comprise an energy management component 402 and an encryption component 404.

In various embodiments, the energy management component 402 can monitor and manage the allocation, distribution, and usage of energy resources in the vehicle. In various aspects, the energy management component 402 can optimize its processes and energy usage of vehicle operation by engaging the quantum computing component 110. More specifically, the quantum computing component 110 can utilize quantum algorithms to handle intricate optimization tasks involving multiple variables and constraints and result in optimized energy usage strategies of vehicle operations (e.g., quantum optimized charging and discharging strategies for electric vehicle batteries, considering factors like energy costs, battery degradation, charger availability, and driving patterns to extend battery life and overall efficiency, quantum-enhanced optimization to enable real-time adjustments of vehicle parameters, such as engine operation and power distribution, to respond to changing conditions). Furthermore, the energy management component 402 can access data collected by the quantum sensors 202 to utilize environment data in quantum algorithms. More specifically, the quantum sensors 202 can provide the energy management component 402 environment data (e.g., temperature, traffic, terrain) to integrate into optimal energy usage strategies (e.g., integrating traffic and terrain data to adjust electric motor performance and energy consumption).

In various aspects, the encryption component 404 can engage the quantum computing component 110 or the artificial intelligence component 108 to encrypt communications and exchanged data within a vehicle or between a vehicle and an external infrastructure.

In various embodiments, the encryption component 404 can engage the quantum computing component 110 or the artificial intelligence component 108 to encrypt based on the sensitivity of the given data. In various instances, the encryption component 404 can apply the artificial intelligence component 108 to data that poses minor consequences if subject to hacking. For example, hijacking of infotainment systems (media systems, navigation, home screens) in a vehicle often might not cause imminent danger or harm to the vehicle and its passengers. Thus, utilization of artificial intelligence encryption would be adequate in such instances.

In other instances, the encryption component 404 can engage the quantum computing component 110 to utilize quantum encryption to protect sensitive data that would pose danger or severe consequences if subject to hacking. For example, quantum encryption and quantum cryptographic techniques (e.g., Quantum Key Distribution to allow the vehicle and central system, other vehicle, or infrastructure to establish a secret cryptographic key that is shared only between them, Quantum Random Number Generator to generate truly random keys resistant to predictable patterns and exploitation of such predictability) can be applied to electronic control units (e.g., engine performance, braking, steering wheel control). If inadequate encryption is used instead, an attacker may gain control over such control units and manipulate critical functions that can cause severe damage and injury to the vehicle's passengers and surround vehicles (e.g., a hijacked steering wheel causing a collision between the vehicle and another vehicle). As another example, vehicle telematics systems and mobile apps that allow users to control their vehicles remotely can be targeted and might provide entry points for attackers. In such situations, sensitive data (e.g., location history, personal data) can be accessible to hackers and subject to exploitation (e.g., identity theft, stalking). Accordingly, various problems of existing encryption methods can be ameliorated by employing quantum encryption in such situations.

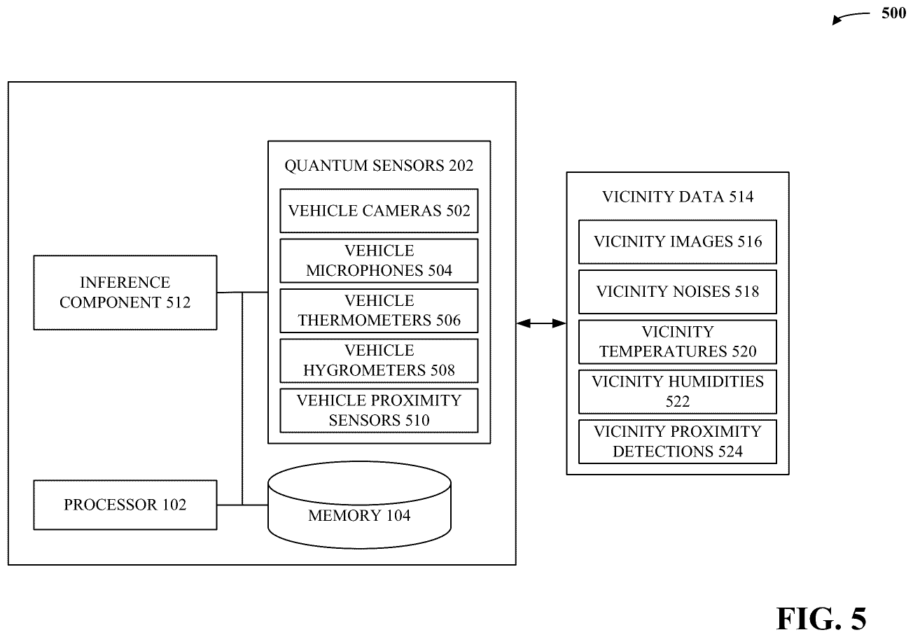

FIG. 5 illustrates a block diagram of an example, non-limiting system 500 that facilitates obstacle detection and fusion of (or multiplexing) classical computing, artificial intelligence, or quantum computing of vehicle operations in accordance with one or more embodiments described herein.

In various aspects, as described herein, the quantum sensors 202 can obtain, via any suitable sensors of the vehicle, vicinity data 514. In various cases, the vicinity data 514 can exhibit any suitable format, size, or dimensionality. For example, the vicinity data 514 can comprise one or more scalars, one or more vectors, one or more matrices, one or more tensors, one or more character strings, or any suitable combination thereof.

In various embodiments, the quantum sensors 202 can electronically control, electronically execute, electronically activate, or otherwise electronically access any suitable sensors of the vehicle. In various aspects, such sensors can be external or road-facing. In other words, such sensors can be oriented or otherwise configured to monitor the vicinity (e.g., the surroundings of the vehicle) as the vehicle drives around or is parked.

As a non-limiting example, such sensors can include a set of vehicle cameras 502. In various aspects, the set of vehicle cameras 502 can include any suitable number of any suitable types of cameras (e.g., of image-capture devices). In various instances, the set of vehicle cameras 502 can be integrated into or onto the vehicle. In various cases, one or more of the set of vehicle cameras 502 can be forward-facing. For example, such one or more cameras can be integrated into or onto any suitable forward-facing surfaces, whether interior or exterior, of the vehicle (e.g., can be built on a dash of the vehicle so as to look through a front windshield of the vehicle, can be built around the front windshield of the vehicle, can be built into a front bumper of the vehicle, can be built around headlights of the vehicle, can be built into a hood of the vehicle). Because such one or more cameras can be forward-facing, such one or more cameras can be configured to capture or otherwise record images or video frames of portions of the vicinity that lie in front of the vehicle. In various aspects, one or more of the set of vehicle cameras 502 can be rearward-facing. For example, such one or more cameras can be integrated into or onto any suitable rearward-facing surfaces, whether interior or exterior, of the vehicle (e.g., can be built into or on a rearview mirror of the vehicle, can be built into or onto sideview mirrors of the vehicle, can be built around a rear windshield of the vehicle, can be built into a rear bumper of the vehicle, can be built around taillights of the vehicle, can be built into a trunk-cover of the vehicle). Because such one or more cameras can be rearward-facing, such one or more cameras can be configured to capture or otherwise record images or video frames of portions of the vicinity that lie behind the vehicle. In various instances, one or more of the set of vehicle cameras 502 can be laterally-facing. For example, such one or more cameras can be integrated into or onto any suitable lateral surfaces, whether interior or exterior, of the vehicle (e.g., can be built into or around doors or door handles of the vehicle, can be built into or around fenders of the vehicle). Because such one or more cameras can be laterally-facing, such one or more cameras can be configured to capture or otherwise record images or video frames of portions of the vicinity that lie beside the vehicle.

As another non-limiting example, such sensors can include a set of vehicle microphones 504. In various aspects, the set of vehicle microphones 504 can include any suitable number of any suitable types of microphones (e.g., of sound-capture devices). In various instances, the set of vehicle microphones 504 can be integrated into or onto the vehicle. In various cases, one or more of the set of vehicle microphones 504 can be forward-facing. For example, such one or more microphones can be integrated into or onto any suitable forward-facing surfaces, whether interior or exterior, of the vehicle, so as to capture or otherwise record sounds or noises that occur in portions of the vicinity that lie in front of the vehicle. In various aspects, one or more of the set of vehicle microphones 504 can be rearward-facing. For example, such one or more microphones can be integrated into or onto any suitable rearward-facing surfaces, whether interior or exterior, of the vehicle, so as to capture or otherwise record sounds or noises that occur in portions of the vicinity that lie behind the vehicle. In various instances, one or more of the set of vehicle microphones 504 can be laterally-facing. For example, such one or more microphones can be integrated into or onto any suitable lateral surfaces, whether interior or exterior, of the vehicle, so as to capture or otherwise record sounds or noises that occur in portions of the vicinity that lie beside the vehicle.

As yet another non-limiting example, such sensors can include a set of vehicle thermometers 506. In various aspects, the set of vehicle thermometers 506 can include any suitable number of any suitable types of thermometers (e.g., of temperature sensors). In various instances, the set of vehicle thermometers 506 can be integrated into or onto the vehicle. In various cases, one or more of the set of vehicle thermometers 506 can be forward-facing. For example, such one or more thermometers can be integrated into or onto any suitable forward-facing surfaces, whether interior or exterior, of the vehicle, so as to capture or otherwise record air temperatures or road surface temperatures associated with portions of the vicinity that lie in front of the vehicle. In various aspects, one or more of the set of vehicle thermometers 506 can be rearward-facing. For example, such one or more thermometers can be integrated into or onto any suitable rearward-facing surfaces, whether interior or exterior, of the vehicle, so as to capture or otherwise record air temperatures or road surface temperatures associated with portions of the vicinity that lie behind the vehicle. In various instances, one or more of the set of vehicle thermometers 506 can be laterally-facing. For example, such one or more thermometers can be integrated into or onto any suitable lateral surfaces, whether interior or exterior, of the vehicle, so as to capture or otherwise record air temperatures or road surface temperatures associated with portions of the vicinity that lie beside the vehicle.

As even another non-limiting example, such sensors can include a set of vehicle hygrometers 508. In various aspects, the set of vehicle hygrometers 508 can include any suitable number of any suitable types of hygrometers (e.g., of moisture or humidity sensors). In various instances, the set of vehicle hygrometers 508 can be integrated into or onto the vehicle. In various cases, one or more of the set of vehicle hygrometers 508 can be forward-facing. For example, such one or more hygrometers can be integrated into or onto any suitable forward-facing surfaces, whether interior or exterior, of the vehicle, so as to capture or otherwise record air humidities or road surface moisture levels associated with portions of the vicinity that lie in front of the vehicle. In various aspects, one or more of the set of vehicle hygrometers 508 can be rearward-facing. For example, such one or more hygrometers can be integrated into or onto any suitable rearward-facing surfaces, whether interior or exterior, of the vehicle, so as to capture or otherwise record air humidities or road surface moisture levels associated with portions of the vicinity that lie behind the vehicle. In various instances, one or more of the set of vehicle hygrometers 508 can be laterally-facing. For example, such one or more hygrometers can be integrated into or onto any suitable lateral surfaces, whether interior or exterior, of the vehicle, so as to capture or otherwise record air humidities or road surface moisture levels associated with portions of the vicinity that lie beside the vehicle.

As still another non-limiting example, such sensors can include a set of vehicle proximity sensors 510. In various aspects, the set of vehicle proximity sensors 510 can include any suitable number of any suitable types of proximity sensors (e.g., of radar, ultrasound, laser, sonar, or lidar sensors). In various instances, the set of vehicle proximity sensors 510 can be integrated into or onto the vehicle. In various cases, one or more of the set of vehicle proximity sensors 510 can be forward-facing. For example, such one or more proximity sensors can be integrated into or onto any suitable forward-facing surfaces, whether interior or exterior, of the vehicle, so as to capture or otherwise record proximities of tangible objects located in portions of the vicinity that lie in front of the vehicle. In various aspects, one or more of the set of vehicle proximity sensors 510 can be rearward-facing. For example, such one or more proximity sensors can be integrated into or onto any suitable rearward-facing surfaces, whether interior or exterior, of the vehicle, so as to capture or otherwise record proximities of tangible objects located in portions of the vicinity that lie behind the vehicle. In various instances, one or more of the set of vehicle proximity sensors 510 can be laterally-facing. For example, such one or more proximity sensors can be integrated into or onto any suitable lateral surfaces, whether interior or exterior, of the vehicle, so as to capture or otherwise record proximities of tangible objects located in portions of the vicinity that lie beside the vehicle.

In any case, the quantum sensors 202 can utilize such sensors to capture, record, or otherwise measure the vicinity data 514.

For example, the set of vehicle cameras 502 can capture a set of vicinity images 516 while the vehicle is driving or parked. In various aspects, the set of vicinity images 516 can include any suitable number of images or video frames (e.g., any suitable number of two-dimensional pixel arrays) that can depict portions of the vicinity (e.g., portions of the vicinity that lie in front of, behind, or beside the vehicle).

As another example, the set of vehicle microphones 504 can capture a set of vicinity noises 518 while the vehicle is driving or parked. In various instances, the set of vicinity noises 518 can include any suitable number of audio clips that can represent noises occurring in portions of the vicinity (e.g., in portions of the vicinity that lie in front of, behind, or beside the vehicle).

As yet another example, the set of vehicle thermometers 506 can capture a set of vicinity temperatures 520 while the vehicle is driving or parked. In various aspects, the set of vicinity temperatures 520 can include any suitable number of temperature measurements that can represent air temperatures or road surface temperatures associated with portions of the vicinity (e.g., with portions of the vicinity that lie in front of, behind, or beside the vehicle).

As still another example, the set of vehicle hygrometers 508 can capture a set of vicinity humidities 522 while the vehicle is driving or parked. In various aspects, the set of vicinity humidities 522 can include any suitable number of humidity measurements or moisture measurements that can represent air humidity levels or road surface moisture levels associated with portions of the vicinity (e.g., with portions of the vicinity that lie in front of, behind, or beside the vehicle).

As even another example, the set of vehicle proximity sensors 510 can capture a set of vicinity proximity detections 524 while the vehicle is driving or parked. In various aspects, the set of vicinity proximity detections 524 can include any suitable number of proximity detections (e.g., of radar, sonar, or lidar detections) that can represent distances between the vehicle and nearby objects located in portions of the vicinity (e.g., in portions of the vicinity that lie in front of, behind, or beside the vehicle).

In any case, the set of vicinity images 516, the set of vicinity noises 518, the set of vicinity temperatures 520, the set of vicinity humidities 522, and the set of vicinity proximity detections 524 can collectively be considered as the vicinity data 514.

In various embodiments, the system 500 can comprise an inference component 512. In various instances, as described herein, the inference component 512 can detect roadway obstacles that occur within the vicinity, based on the vicinity data 514.

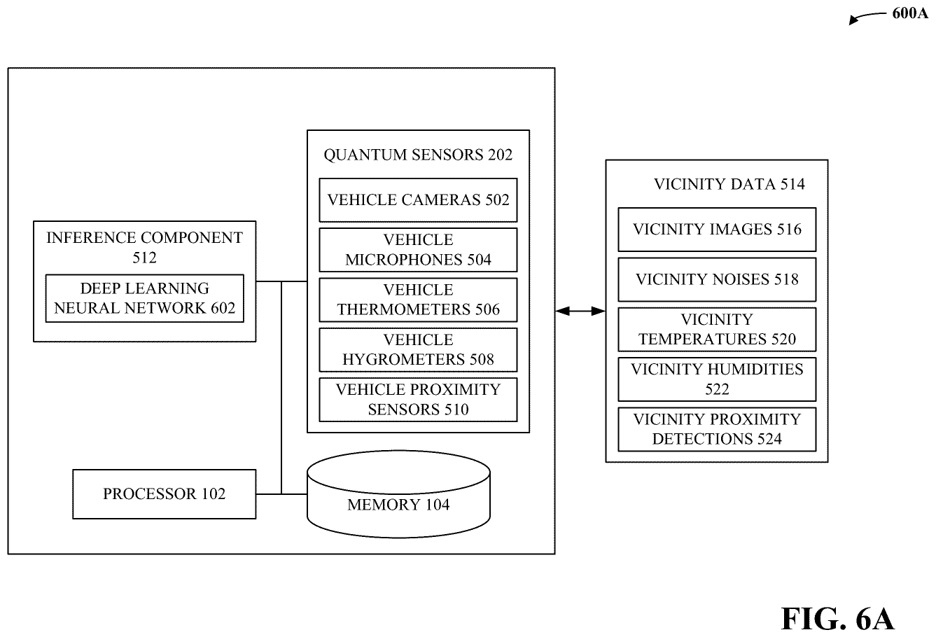

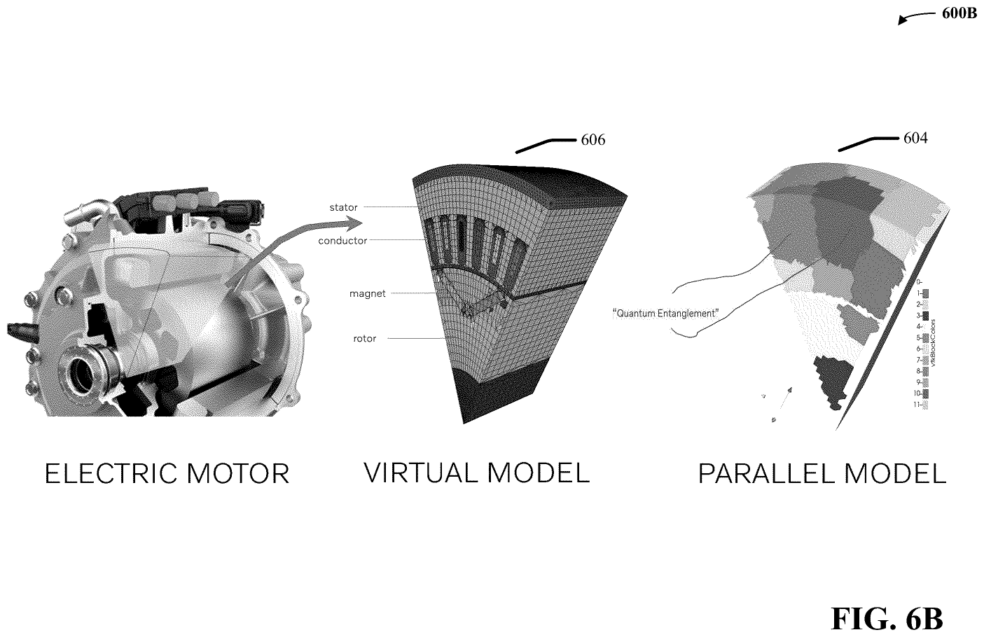

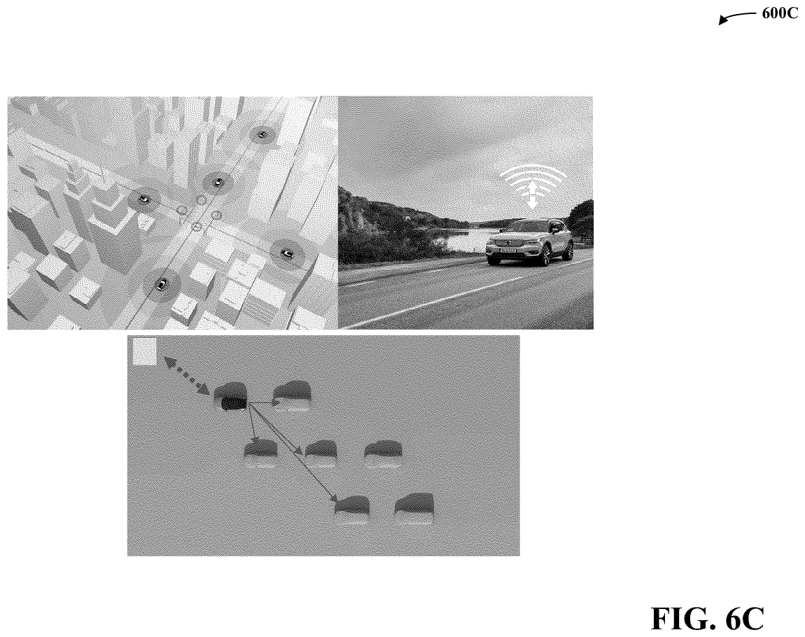

FIG. 6A illustrates a block diagram of an example, non-limiting system 600A including a deep learning neural network that can facilitate obstacle detection and fusion of (or multiplexing) classical computing, artificial intelligence, or quantum computing of vehicle operations in accordance with one or more embodiments described herein. As shown, the system 600A can, in some cases, comprise the same components as the system 500, and can further comprise a deep learning neural network 602.

In various embodiments, the inference component 512 can electronically store, electronically maintain, electronically control, or otherwise electronically access the deep learning neural network 602. In various aspects, the deep learning neural network 602 can have or otherwise exhibit any suitable internal architecture. For instance, the deep learning neural network 602 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

In various embodiments, the deep learning neural network 602 can utilize the quantum computing component 110 to enhance and accelerate deep learning. More specifically, the deep learning component 602 can engage the quantum computing component 110 to accelerate the training process and optimize network configurations through quantum algorithms (e.g., Quantum Approximate Optimization Algorithm). Furthermore, utilization of quantum computing can enable feature space expansion in the deep learning neural network 602. For example, quantum data encoding techniques can be used to transform the vicinity data 514 into higher-dimensional quantum states, enhancing the network's ability to learn intricate patterns. Moreover, the quantum computing component 110 can perform data preprocessing tasks on the vicinity data 514 before the deep learning neural network 602 processes the vicinity data 514. (e.g., dimensionality reduction to reduce computational intensity and refined data representation, feature selection to enable discovery of latent features through quantum encoding, data clustering to cluster quantum states and reveal further data patterns). Thus, as another example, when the deep learning neural network 602 is accessed by the inference component 512, the inference component 512 can accurately and precisely detect obstacles in adverse or unusual conditions (e.g., detecting roadway obstacles in a whiteout, safely navigating a complex traffic situation in an autonomous vehicle).

No matter the internal architecture of the deep learning neural network 602, the deep learning neural network 602 can be configured to detect surrounding obstacles based on inputted vicinity data.

In various instances, the inference component 512 can, in various aspects, execute the deep learning neural network 602 on the vicinity data 514, and such execution can cause the deep learning neural network 602 to detect obstacles or potential hazards in the vicinity. More specifically, the inference component 512 can feed the vicinity data 514 (e.g., the set of vicinity images 516, the set of vicinity noises 518, the set of vicinity temperatures 520, the set of vicinity humidities 522, or the set of vicinity proximity detections 524) to an input layer of the deep learning neural network 602. In various instances, the vicinity data 514 (e.g., the set of vicinity images 516, the set of vicinity noises 518, the set of vicinity temperatures 520, the set of vicinity humidities 522, or the set of vicinity proximity detections 524) can complete a forward pass through one or more hidden layers of the deep learning neural network 602. In various cases, an output layer of the deep learning neural network 602 can detect obstacles, based on activation maps or intermediate features produced by the one or more hidden layers.

FIG. 6B illustrates a block diagram of an example, non-limiting system 600B that can facilitate fusion of (or multiplexing) classical computing, artificial intelligence, or quantum computing of vehicle operations in accordance with one or more embodiments described herein.

In various embodiments, the system 300B can comprise a virtual model 606 that can further comprise a stator, conductor, magnet, rotor, and electric motor. In various embodiments, the virtual model 606 can utilize a parallel model 604 that comprises a computational mesh of multiple computation domains on separate CPU's for high detail vehicle model complementing the environmental model serving decision base for autonomous driving. Conventional systems are incapable of handling such large modelling tasks in an in-car CPU capacity. Utilizing quantum entanglement to connect the separate CPU's rather than a physical connection (e.g., InfiniBand) in conventional systems can enable the quantum computing component 110 of each CPU to share modeling task sub-solution domains. For example, to model real-time sensor data for decision-making in autonomous driving navigation, the parallel model 604 can divide the vehicle's tasks into sub-domains (e.g., sensor data processing, decision-making, control) after collecting vast amounts of data from the quantum sensors 202. Quantum algorithms can be utilized to optimize sensor fusion while preprocessed sensor data can be shared between vehicles through quantum entanglement. Furthermore, a decision-making sub-domain, for instance, can communicate decision data to other vehicles (e.g., lane changes, speed adjustments, route planning). The parallel model 604 enables real-time adaptation to changing road conditions (e.g., traffic patterns, vehicle behaviors like thermal, electromagnetic and structural loads, accurately model and predict at a digital-twin level) and a comprehensive and accurate view of the environment.

FIG. 6C illustrates diagrams of an example, non-limiting system 600C that can facilitate fusion of (or multiplexing) classical computing, artificial intelligence, or quantum computing of vehicle operations in accordance with one or more embodiments described herein.

In various embodiments, quantum computing modules can share information and data through vehicle-to-everything (V2X) communication. In various instances, utilizing quantum entanglement to execute V2X communication can enable shared pattern recognition between both vehicles and other elements of the urban or extra urban infrastructure. More specifically, the quantum computing module of one vehicle can delegate pattern recognition tasks (e.g., traffic sign detection) to the quantum computing module on a separate entity still handling other tasks itself.

In various embodiments, quantum computing modules can share information and data through vehicle-to-everything (V2X) communication. In various instances, utilizing quantum entanglement to execute V2X communication can enable shared ability for data crunching for edge or cloud service providers as a vehicle-provided service while on-board autonomous driving systems are not active or used with low load.

In various embodiments, quantum computing modules can share information and data through vehicle-to-everything (V2X) communication. In various instances, utilizing quantum entanglement to execute V2X communication can enable shared ability for data crunching for mobile phone operators as a vehicle-provided service while on-board autonomous driving systems are not active or used with low load.

In various embodiments, quantum computing modules can share information and data through vehicle-to-everything (V2X) communication. In various instances, utilizing quantum entanglement to execute V2X communication can enable shared ability for data crunching and proxy for internet access providers as a vehicle-provided service while on-board autonomous driving systems are not active or used with low load.

In various embodiments, quantum computing modules can share information and data through vehicle-to-everything (V2X) communication. In various instances, utilizing quantum entanglement to execute V2X communication can enable shared ability for data crunching for content providers as a vehicle-provided service while on-board autonomous driving systems are not active or used with low load.

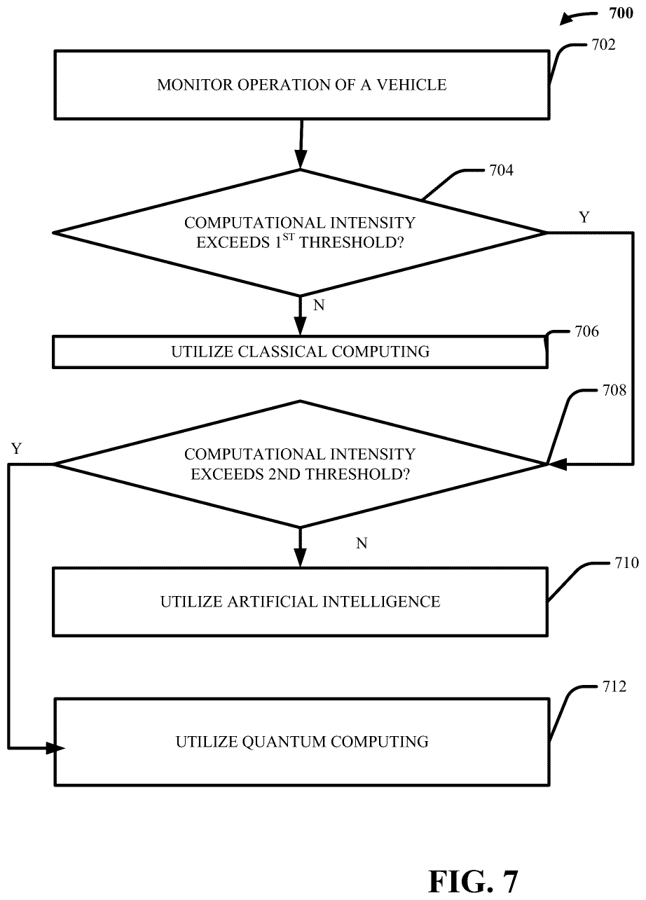

FIG. 7 illustrates a flow diagram of an example, non-limiting computer-implemented method 700 that can facilitate fusion of (or multiplexing) classical computing, artificial intelligence, or quantum computing of vehicle operations in accordance with one or more embodiments described herein. In various cases, the system 100 can facilitate the computer-implemented method 700.

In various embodiments, act 702 can include monitoring operation of a vehicle.

In various cases, act 704 can include determining, by the fusion component (e.g., via 112), whether the computational intensity of a vehicle operation exceeds the first threshold. If not (e.g., if the computational intensity of a vehicle operation does not exceed the first threshold), the computer-implemented method 700 can proceed to act 706. If so (e.g., if computational intensity of a vehicle operation does exceed the first threshold), the computer-implemented method 700 can proceed to act 708.

In various aspects, act 706 can include utilizing, by the fusion component (e.g., via 112) classical computing.

In various cases, act 708 can include determining, by the fusion component (e.g., via 112), whether the computational intensity of a vehicle operation exceeds the second threshold. If not (e.g., if the computational intensity of a vehicle operation does not exceed the second threshold), the computer-implemented method 700 can proceed to act 710. If so (e.g., if computational intensity of a vehicle operation does exceed the first threshold), the computer-implemented method 700 can proceed to act 712.

In various aspects, act 710 can include utilizing, by the fusion component (e.g., via 112) artificial intelligence.

In various aspects, act 712 can include utilizing, by the fusion component (e.g., via 112) quantum computing.

For example, the monitored vehicle operation can be accelerating artificial intelligence pattern recognition for detecting roadway obstacles. The fusion component 112 can determine that accelerating artificial intelligence pattern recognition has a computational intensity that exceeds the first threshold, therefore proceeding to act 708. The fusion component 112 can then determine that accelerating artificial intelligence pattern recognition has a computational intensity that exceeds the second threshold, therefore proceeding to act 712. Accordingly, quantum computing can be utilized because the fusion component 112 determined that accelerating artificial intelligence pattern recognition has a computational intensity that exceeds the first and second threshold.

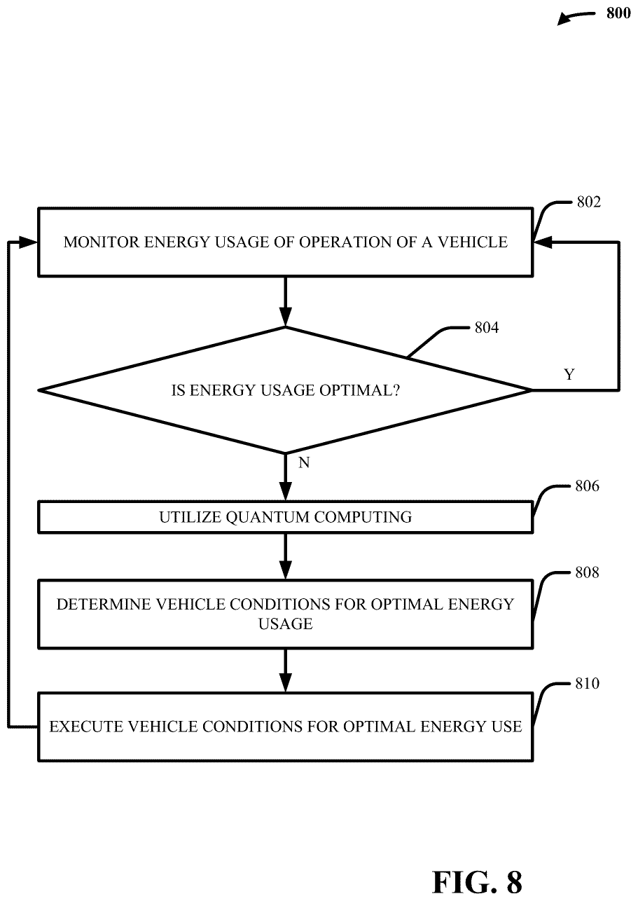

FIG. 8 illustrates a flow diagram of an example, non-limiting computer-implemented method 800 that can facilitate fusion classical computing, artificial intelligence, and quantum computing of vehicle operations in accordance with one or more embodiments described herein. In various cases, the system 100 can facilitate the computer-implemented method 800.

In various embodiments, act 802 can include monitoring energy usage of operations of a vehicle, via internal vehicle sensors and external quantum sensors.

In various cases, act 804 can include determining, by the energy management component (e.g., via 402), whether energy usage of vehicle operations is optimal. If not (e.g., if the energy usage of vehicle operations is not optimal), the computer-implemented method 800 can proceed to act 806. If so (e.g., if energy usage of vehicle operations is optimal), the computer-implemented method 800 can proceed to act 802.

In various aspects, act 806 can include utilizing, by the energy management component (e.g., via 402) quantum computing.

In various aspects, act 808 can include determining, by the quantum computing component (e.g., via 110) vehicle conditions for optimal energy usage.

In various aspects, act 810 can include executing, by the energy management component (e.g., via 402) vehicle conditions for optimal energy usage.

As an example, energy consumption of a battery can be monitored in an electric vehicle as the vehicle is driving through snow. The energy management component 402 can determine if the battery's energy consumption is optimal. For instance, it can be determined that energy consumption is not optimal for driving through snowy weather, therefore proceeding to act 806. Quantum computing can then be utilized to determine the optimal conditions considering various factors (e.g., adjusted speed, adjusted driving strategy to keep the battery at an optimal temperature to maximize range and efficiency, regenerative braking if going downhill). The optimal conditions can then be executed to optimize energy usage while driving in snow.

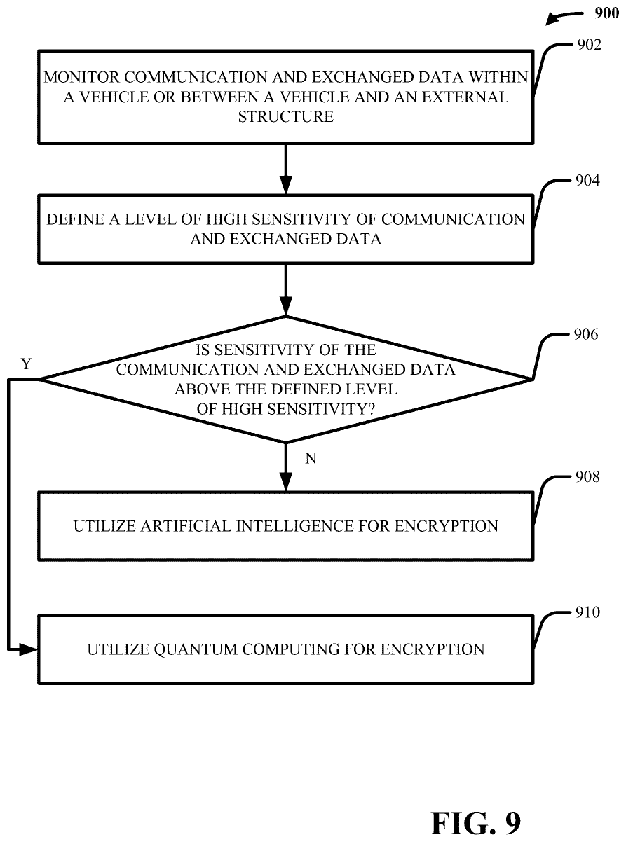

FIG. 9 illustrates a flow diagram of an example, non-limiting computer-implemented method 900 that can facilitate fusion of (or multiplexing) classical computing, artificial intelligence, or quantum computing of vehicle operations in accordance with one or more embodiments described herein. In various cases, the system 100 can facilitate the computer-implemented method 900.

In various embodiments, act 902 can include monitoring, by the encryption component (e.g., 404) communication and exchanged data within a vehicle or between a vehicle and an external infrastructure.

In various aspects, act 904 can include defining, by the encryption component (e.g., 404) a level of high sensitivity of the communication and exchanged data.

In various cases, act 906 can include determining, by the encryption component (e.g., via 404), whether the sensitivity of the communication and exchanged data is above the defined level of high sensitivity. If not (e.g., if the sensitivity of the communication and exchanged data is not above the defined level of high sensitivity), the computer-implemented method 900 can proceed to act 908. If so (e.g., if the sensitivity of the communication and exchanged data is above the defined level of high sensitivity), the computer-implemented method 900 can proceed to act 910.

In various embodiments, act 908 can include utilizing, by the encryption component (e.g., 404) artificial intelligence for encryption.

In various aspects, act 910 can include utilizing, by the encryption component (e.g., 404) quantum computing for encryption.

For example, the encryption component 404 can monitor biometric data of a driver. The encryption component 404 can then determine or utilize a predefined level of high sensitivity of data. For instance, any data containing personal information regarding the driver or passengers can be considered to be above the determined level of high sensitivity. Thus, driver biometric data would be determined to be above the defined level of high sensitivity, proceeding to act 910. Accordingly, quantum encryption can be utilized to encrypt the biometric data to ensure data privacy and security.

Although the herein disclosure mainly describes various embodiments as implementing deep learning neural networks (e.g., 602), this is a mere non-limiting example. In various aspects, the herein-described teachings can be implemented via any suitable machine learning models exhibiting any suitable artificial intelligence architectures (e.g., support vector machines, naïve Bayes, linear regression, logistic regression, decision trees, random forest, reinforcement learning) or quantum computing architectures.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence (class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

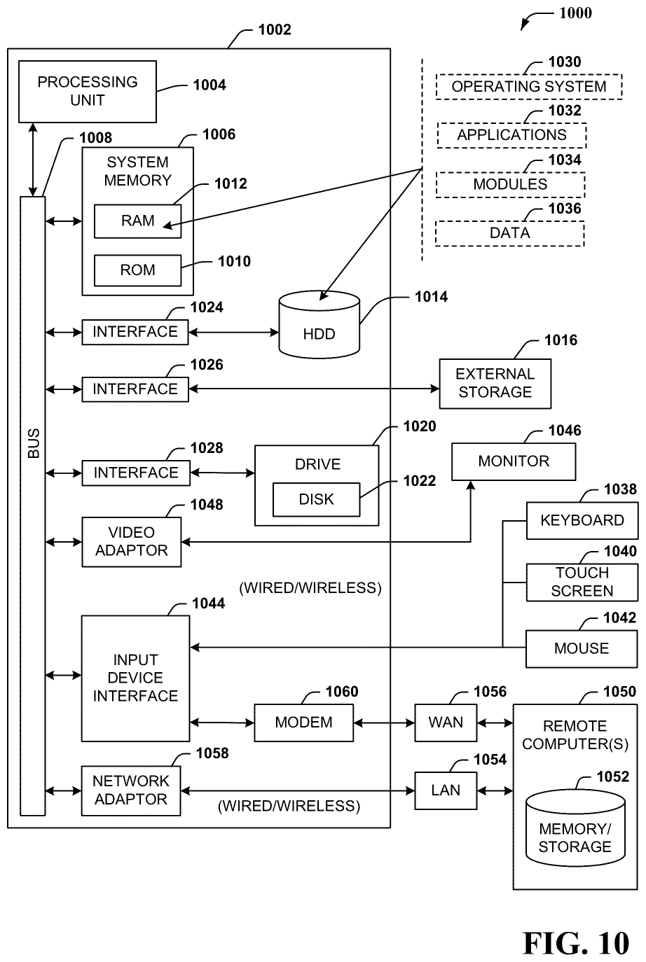

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can include, but are not limited to, quantum memories, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and a drive 1020, e.g., such as a solid state drive, an optical disk drive, which can read or write from a disk 1022, such as a CD-ROM disc, a DVD, a BD, etc. Alternatively, where a solid state drive is involved, disk 1022 would not be included, unless separate. While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and drive 1020 can be connected to the system bus 1008 by an HDD interface 1024, an external storage interface 1026 and a drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

The computer 1002 can operate in a networked environment using logical connections via wireless communications based GPRS, GSM, 5G, LTE, 6G protocols.

When used in a LAN networking environment, the computer 1002 can be connected to the local network 1054 through a wired or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above, such as but not limited to a network virtual machine providing one or more aspects of storage or processing of information. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

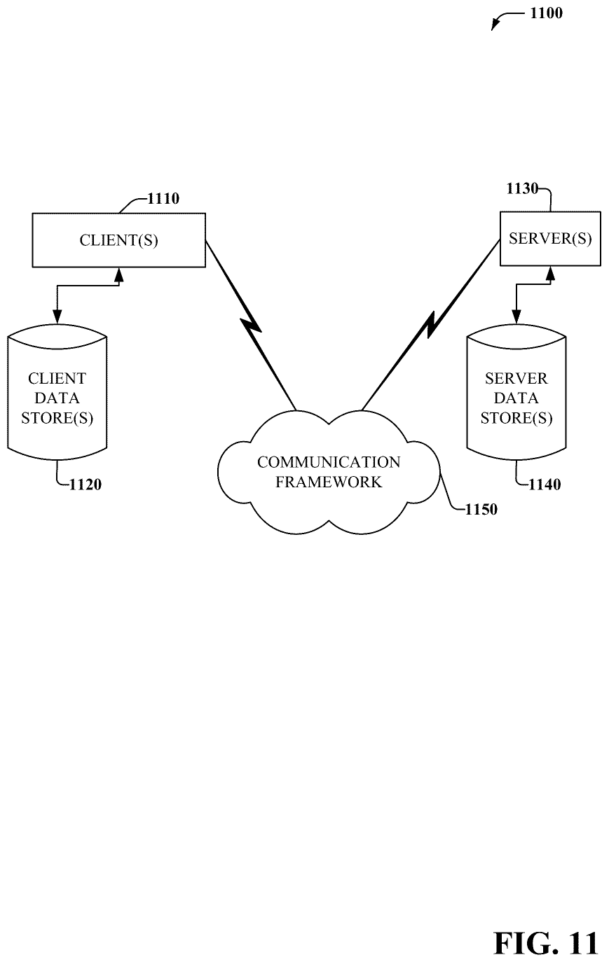

FIG. 11 is a schematic block diagram of a sample computing environment 1100 with which the disclosed subject matter can interact. The sample computing environment 1100 includes one or more client(s) 4110. The client(s) 4110 can be hardware or software (e.g., threads, processes, computing devices). The sample computing environment 1100 also includes one or more server(s) 1130. The server(s) 1130 can also be hardware or software (e.g., threads, processes, computing devices). The servers 1130 can house threads to perform transformations by employing one or more embodiments as described herein, for example. One possible communication between a client 4110 and a server 1130 can be in the form of a data packet adapted to be transmitted between two or more computer processes. The sample computing environment 1100 includes a communication framework 1150 that can be employed to facilitate communications between the client(s) 4110 and the server(s) 1130. The client(s) 4110 are operably connected to one or more client data store(s) 1120 that can be employed to store information local to the client(s) 4110. Similarly, the server(s) 1130 are operably connected to one or more server data store(s) 1140 that can be employed to store information local to the servers 1130.

The present invention may be a system, a method, an apparatus or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations or block diagrams of methods, apparatus (systems), and computer program products according to embodiments of the invention. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various non-limiting aspects of various embodiments described herein are presented in the following clauses.

Clause 1: A system, comprising: a processor that executes computer-executable components stored in a non-transitory quantum or non-quantum computer-readable memory, the computer-executable components comprising: a classical computing component; an artificial intelligence component; a quantum computing component; and a fusion component that dynamically engages one of more of the classical computing component, the artificial intelligence component or the quantum computing component in connection with operation of a vehicle.

Clause 2: The system of any preceding clause, wherein the fusion component engages the quantum computing component to operative quantum-enhanced sensors to provide accurate and sensitive measurements of various physical quantities.

Clause 3: The system of any preceding clause, wherein the fusion component respectively assigns tasks to the classical computing component, the artificial intelligence component or the quantum computing component as a function of relative computing strength for given tasks.

Clause 4: The system of any preceding clause, wherein the fusion component engages the classical computing component for routine control tasks, basic sensor data processing, and compute-intensive operations below a first threshold.

Clause 5: The system of any preceding clause, wherein the fusion component engages the artificial intelligence component to manage complex decision-making, object recognition, natural language processing for human-vehicle interaction, and predictive modeling below a second threshold and above the first threshold for computational intensity.

Clause 6: The system of any preceding clause, wherein the fusion component engages the quantum computing component to specific problems where quantum algorithms provide a significant advantage over classical computing and artificial intelligence above the second threshold for computational intensity.

Clause 7: The system of any preceding clause, wherein the fusion component engages the quantum computing component to optimizing complex vehicle routing in real-time.

Clause 8: The system of any preceding clause, wherein the fusion component engages the quantum computing component to optimize energy usage using an energy management component or encryption in real-time using an encryption component.

Clause 9: The system of any preceding clause, wherein the fusion component engages the quantum computing component as a specialized accelerators for specific tasks.

Clause 10: The system of any preceding clause, wherein the fusion component engages the quantum computing component to improve artificial intelligence models for adaptive processes using real-world data.

Clause 11: The system of any preceding clause, wherein the fusion component engages the quantum computing component at least one of the following data preprocessing tasks: feature selection, dimensionality reduction, or data clustering.

Clause 12: The system of any preceding clause, wherein the fusion component engages the quantum computing component to speed up certain pattern recognition problems when combined with the artificial intelligence component for image recognition using a quantum-enhanced vision system.

Clause 13: The system of any preceding clause, wherein the fusion component engages the quantum computing component to secure vehicle communications through quantum encryption using quantum cryptographic techniques.

In various cases, any suitable combination or combinations of clauses 1-13 can be implemented.

Clause 14: A computer-implemented method, comprising: using a fusion component to dynamically engage one of more of a classical computing component, an artificial intelligence component or a quantum computing component in connection with operation of a vehicle.

Clause 15: The computer-implemented method of any preceding clause, further comprising engaging the quantum computing component to operate quantum-enhanced sensors to provide accurate and sensitive measurements of various physical quantities.

Clause 16: The computer-implemented method of any preceding clause, further comprising respectively assigning tasks to the classical computing component, the artificial intelligence component or the quantum computing component as a function of relative computing strength for given tasks.

Clause 17: The computer-implemented method of any preceding clause, further comprising engaging the quantum computing component for specific problems where quantum algorithms provide a significant advantage over classical computing and artificial intelligence above the second threshold for computational intensity.

Clause 18: The computer-implemented method of any preceding clause, further comprising engaging the quantum computing component to optimizing complex vehicle routing in real-time.

In various cases, any suitable combination or combinations of clauses 14-18 can be implemented.

Clause 19: A computer program product comprising a non-transitory quantum or non-quantum computer-readable memory having program instructions embodied therewith, the program instructions executable by a processor to cause the processor to: use a fusion component to dynamically engage one of more of a classical computing component, an artificial intelligence component or a quantum computing component in connection with operation of a vehicle.

Clause 20: The computer program product of any preceding clause, wherein the program instructions are further executable to cause the processor to: operate quantum-enhanced sensors to provide accurate and sensitive measurements of various physical quantities.

In various cases, any suitable combination or combinations of clauses 19-20 can be implemented.

In various cases, any suitable combination or combinations of clauses 1-20 can be implemented.

What is claimed is:

1. A system, comprising:
a processor that executes computer-executable components stored in a non-transitory quantum or non-quantum computer-readable memory, the computer-executable components comprising:
a classical computing component;
an artificial intelligence component;
a quantum computing component; and
a fusion component that dynamically engages one of more of the classical computing component, the artificial intelligence component or the quantum computing component in connection with operation of a vehicle.

2. The system of claim 1, wherein the fusion component engages the quantum computing component to operative quantum-enhanced sensors to provide accurate and sensitive measurements of various physical quantities.

3. The system of claim 1, wherein the fusion component respectively assigns tasks to the classical computing component, the artificial intelligence component or the quantum computing component as a function of relative computing strength for given tasks.

4. The system of claim 3, wherein the fusion component engages the classical computing component for routine control tasks, basic sensor data processing, and compute-intensive operations below a first threshold.

5. The system of claim 3, wherein the fusion component engages the artificial intelligence component to manage complex decision-making, object recognition, natural language processing for human-vehicle interaction, and predictive modeling below a second threshold and above the first threshold for computational intensity.

6. The system of claim 3, wherein the fusion component engages the quantum computing component to specific problems where quantum algorithms provide a significant advantage over classical computing and artificial intelligence above the second threshold for computational intensity.

7. The system of claim 6, wherein the fusion component engages the quantum computing component to optimizing complex vehicle routing in real-time.

8. The system of claim 1, wherein the fusion component engages the quantum computing component to optimize energy usage using an energy management component or encryption in real-time using an encryption component.

9. The system of claim 1, wherein the fusion component engages the quantum computing component as a specialized accelerators for specific tasks.

10. The system of claim 1, wherein the fusion component engages the quantum computing component to improve artificial intelligence models for adaptive processes using real-world data.

11. The system of claim 1, wherein the fusion component engages the quantum computing component at least one of the following data preprocessing tasks: feature selection, dimensionality reduction, or data clustering.

12. The system of claim 1, wherein the fusion component engages the quantum computing component to speed up certain pattern recognition problems when combined with the artificial intelligence component for image recognition using a quantum-enhanced vision system.

13. The system of claim 1, wherein the fusion component engages the quantum computing component to secure vehicle communications through quantum encryption using quantum cryptographic techniques.

14. A computer-implemented method, comprising:
using a fusion component to dynamically engage one of more of a classical computing component, an artificial intelligence component or a quantum computing component in connection with operation of a vehicle.

15. The computer-implemented method of claim 14, further comprising engaging the quantum computing component to operate quantum-enhanced sensors to provide accurate and sensitive measurements of various physical quantities.

16. The computer-implemented method of claim 14, further comprising respectively assigning tasks to the classical computing component, the artificial intelligence component or the quantum computing component as a function of relative computing strength for given tasks.

17. The computer-implemented method of claim 14, further comprising engaging the quantum computing component for specific problems where quantum algorithms provide a significant advantage over classical computing and artificial intelligence above the second threshold for computational intensity.

18. The computer-implemented method of claim 14, further comprising engaging the quantum computing component to optimizing complex vehicle routing in real-time.

19. A computer program product comprising a non-transitory quantum or non-quantum computer-readable memory having program instructions embodied therewith, the program instructions executable by a processor to cause the processor to:
use a fusion component to dynamically engage one of more of a classical computing component, an artificial intelligence component or a quantum computing component in connection with operation of a vehicle.

20. The computer program product of claim 19, wherein the program instructions are further executable to cause the processor to: operate quantum-enhanced sensors to provide accurate and sensitive measurements of various physical quantities.
